(19) United States
(12) Patent Application Publication
(10) Pub. No.: US 2008/0192009 A1
(43) Pub. Date: Aug. 14, 2008

(54) STORING STRUCTURE OF WIRELESS MOUSE FOR STORING WIRELESS SIGNAL RECEIVER THEREIN

(75) Inventors: Zhi-Xiang Wu, Dongguan (CN); Hong-Che Yen, Taipei (TW); Chih-Hung Lin, Taipei (TW)

Correspondence Address: APEX JURIS, PLLC, 12360 LAKE CITY WAY NORTHEAST, SUITE 410, SEATTLE, WA, 98125, US

(73) Assignee: Primax Electronics Ltd., Taipei (TW)

(21) Appl. No.: 11/750,549

(22) Filed: May 18, 2007

(30) Foreign Application Priority Data
Feb. 9, 2007 (TW) 096104716

(51) Int. Cl. G06F 3/033

(52) U.S. Cl. 345/163

(57) ABSTRACT

The present invention relates to a storing structure of a wireless mouse for storing a wireless signal receiver therein. The storing structure of the wireless mouse includes a cover member, a carrier and a carrier door. The cover member includes a receiving portion therein. The carrier is disposed in the receiving portion and movable to be protruded from the cover member. The carrier door is pivotally coupled to the carrier.

### FIELD OF THE INVENTION

The present invention relates to a storing structure of a wireless mouse, and more particularly to a storing structure of a wireless mouse for storing a wireless signal receiver therein.

### BACKGROUND OF THE INVENTION

Nowadays, mice, keyboards and earphones become essential peripheral devices of computer systems. Conventionally, these peripheral devices are communicated with the host computer via wire linkage. The wire linkage is very troublesome and inconvenient because an additional signal wire is employed to connect the computer with the peripheral device. For solving these drawbacks, wireless peripheral devices are developed to communicate with the host computer according to a wireless transmission technology. Since no additional wire is required to connect the wireless peripheral devices with the host computer, the space utilization is enhanced.

Take a wireless mouse for example. The signals generated from the wireless mouse are transmitted to the host computer according to wireless communication protocol. The wireless mouse has a wireless emitter therein for emitting a wireless signal. When the wireless mouse is operated, a corresponding wireless signal receiver is used for receiving the wireless signal issued from the wireless mouse. Nowadays, with increasing development of wireless communication technologies, the volume of the wireless signal receiver is largely reduced and convenient for portability. Due to the reduced volume, the probability of losing the wireless signal receiver is increased. For a purpose of solving such a problem, it is important to provide a storing structure for storing a wireless signal receiver therein.

Please refer to FIG. 1, which is a schematic perspective view illustrating a wireless mouse having a storing structure for storing a wireless signal receiver therein. The top cover of the wireless mouse may be uplifted to accommodate the wireless signal receiver into the receiving portion thereof. Generally, the receiving portion is fixed on the top cover via tenons or studs. Unfortunately, if the process of removing/inserting the wireless signal receiver from/into the receiving portion of the wireless mouse is repeatedly done for a long term, the strengths of tenons or studs may be weakened or even fail to be fixed on the top cover. In addition, the tenons may be fractured when the wireless mouse is suffered from a drop or a strong impact.

FIG. 2 is a schematic perspective view of another wireless mouse having a storing structure for storing a wireless signal receiver therein. The wireless mouse has a receiving portion for accommodating the wireless signal receiver therein. After the wireless signal receiver is detached from the wireless mouse, an entrance of the receiving portion is exposed. If no additional sheltering door is used for sheltering the entrance of the receiving portion, the inner components of the wireless mouse are possibly contaminated. After the wireless mouse is used for a long term, the wireless signal receiver may no longer be interference fitted into the receiving portion of the wireless mouse. As a consequence, the wireless signal receiver is likely to loosen or fall off because the wireless signal receiver is not firmly secured within the receiving portion of the wireless mouse.

Therefore, there is a need of providing a wireless mouse having a storing structure for storing a wireless signal receiver therein and facilitating a user to insert/withdraw the wireless signal receiver into/from the receiving portion.

### SUMMARY OF THE INVENTION

It is an object of the present invention to provide a storing structure of a wireless mouse for storing a wireless signal receiver therein and facilitating a user to insert/withdraw the wireless signal receiver into/from the receiving portion without impairing the outward appearance of the wireless mouse.

In accordance with an aspect of the present invention, there is provided a storing structure of a wireless mouse for storing a wireless signal receiver therein. The storing structure of the wireless mouse includes a cover member, a carrier and a carrier door. The cover member includes a receiving portion therein. The carrier is disposed in the receiving portion and movable to be protruded from the cover member. The carrier door is pivotally coupled to the carrier.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic perspective view illustrating a wireless mouse having a storing structure for storing a wireless signal receiver therein;

FIG. 2 is a schematic perspective view of another wireless mouse having a storing structure for storing a wireless signal receiver therein;

FIG. 3 is a schematic exploded view of a storing structure of a wireless mouse according to a preferred embodiment of the present invention;

FIGS. 4A and 4B are schematic assembled views illustrating the wireless mouse of FIG. 3; and

FIGS. 5A and 5B are schematic cross-sectional views illustrating movement of the carrier with respect to the receiving portion.

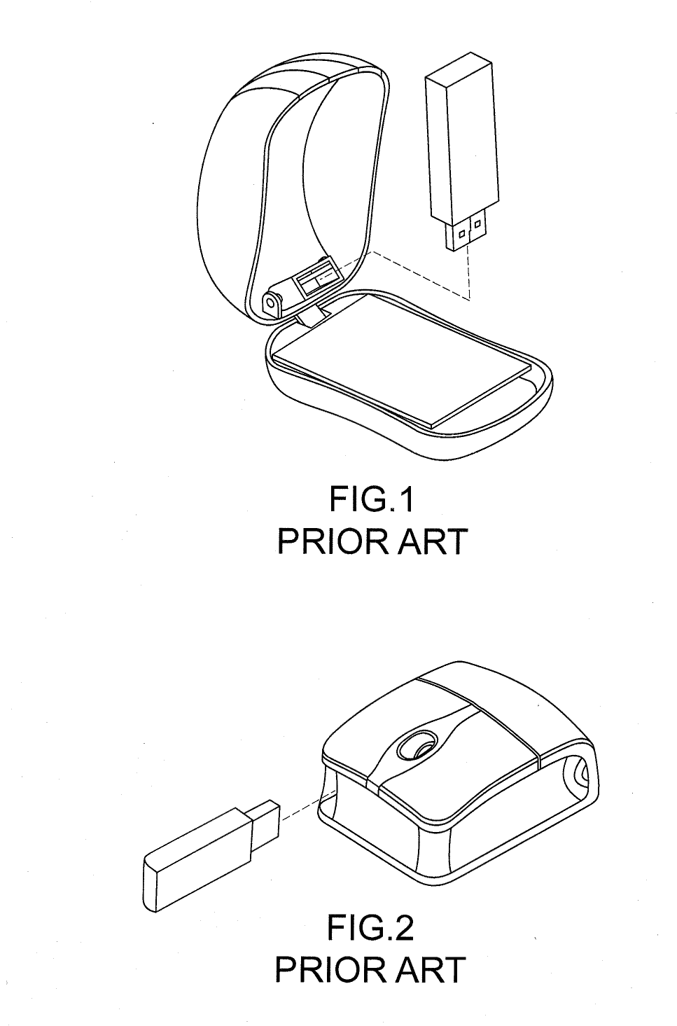

### DETAILED DESCRIPTION OF THE PREFERRED EMBODIMENT

The present invention will be illustrated by referring to a wireless mouse having a storing portion for storing a wireless signal receiver therein. The wireless mouse includes a storing structure and other common components, which includes for example a pointing signal generation unit, a wireless emitter, a circuit board, a battery receptacle, an optical coordinate reader, a compiler, a scroll wheel and a micro switch. The principles of these common components are known in the art, and are not redundantly described herein.

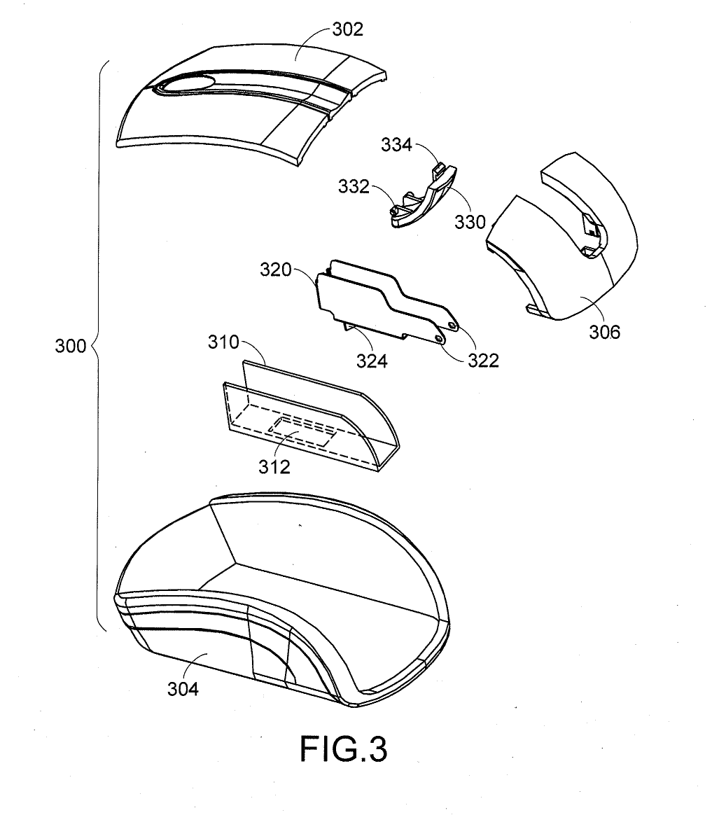

Referring to FIG. 3, a schematic exploded view of a storing structure of a wireless mouse according to a preferred embodiment of the present invention is illustrated. The storing structure of the wireless mouse includes a cover member 300, a receiving portion 310, a carrier 320 and a carrier door 330. The cover member 300 includes an upper cover 302, a lower cover 304 and a rear cover 306. The receiving portion 310 further includes a confining aperture 312 at the bottom thereof. The carrier 32 includes pivotal holes 322 and a confining plate 324. The confining plate 324 is protruded from the bottom surface of the carrier 32. The carrier door 330 includes a rotating shaft 332 and a hooking element 334.

The upper cover 302 is mounted on the lower cover 304. The receiving portion 310 is arranged between the upper cover 302 and the lower cover 304. The carrier 32 is embedded into the receiving portion 310. Since the confining plate 324 at the bottom of the carrier 32 is penetrated through the confining aperture 312, the carrier 32 is movable with respect to the receiving portion 310 and the movable range is determined by the length of the confining aperture 312. The rotating shaft 332 of the carrier door 330 is coupled to the pivotal holes 322 such that the carrier door 330 is rotatable with respect to the rotating shaft 332. Moreover, the hooking element 334 of the carrier door 330 may be engaged with corresponding engaging element (not shown) of the upper cover 302. The carrier door 330 is coupled with the upper cover 302 and the lower cover 304.

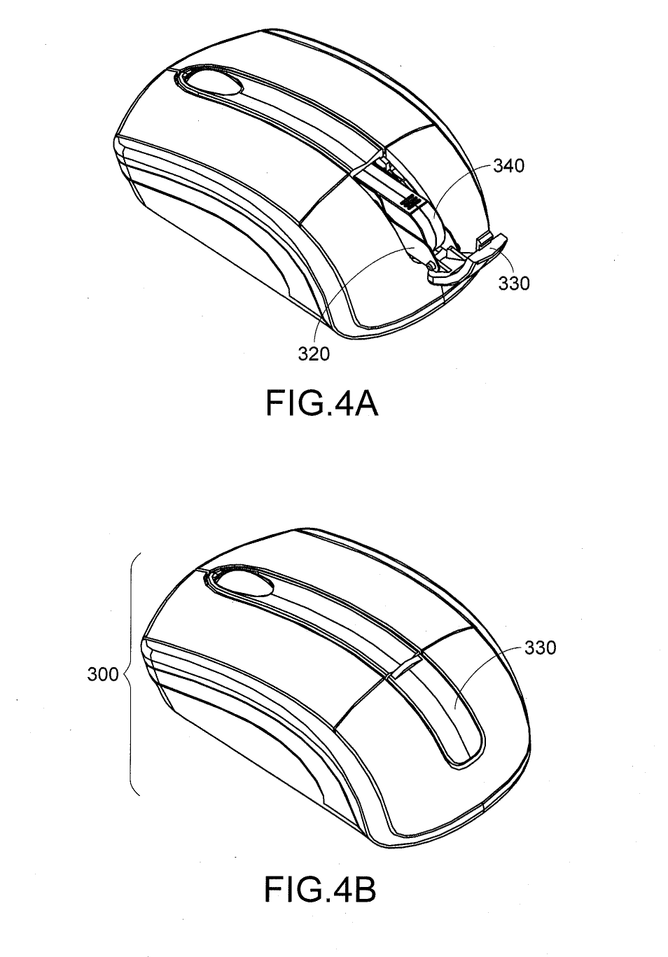

FIGS. 4A and 4B are schematic assembled views illustrating the wireless mouse of FIG. 3. In FIG. 4A, the carrier door 330 is opened and the carrier 320 is partially pulled out so as to expose the wireless signal receiver 340. In FIG. 4B, after the carrier 320 supporting the wireless signal receiver 340 is received in the receiving portion 310, the hooking element 334 of the carrier door 330 is coupled with the upper cover 302 of the cover member 300 so as to close the carrier door 330. Since the entrance of the receiving portion 310 is fully sheltered by the carrier door 330, the outward appearance of the wireless mouse is not affected when the wireless signal receiver 340 is stored in or detached from the cover member 300 of the wireless mouse.

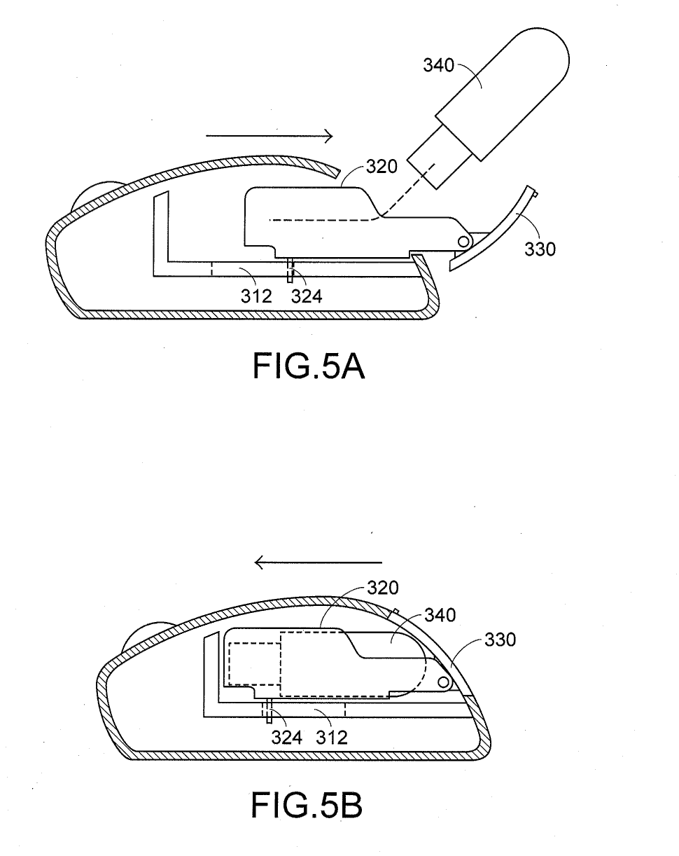

FIGS. 5A and 5B are schematic cross-sectional views illustrating movement of the carrier with respect to the receiving portion.

Hereinafter, a process of removing the wireless signal receiver 340 from the cover member 300 is illustrated as follows. First of all, the hooking element 334 is disengaged from the cover member 300 to expose the wireless signal receiver 340. Then, the carrier 320 is pulled out in the horizontal direction indicated by the arrow, so that the carrier 320 is moved with respect to the receiving portion 310. Until the confining plate 324 of the carrier 320 is sustained against the right-side border of the confining aperture 312 of the receiving portion 310, the carrier door 330 is fully opened. Afterwards, the wireless signal receiver 340 is moved from the cover member 300, as can be seen in FIG. 5A.

Hereinafter, a process of storing the wireless signal receiver 340 within the cover member 300 is illustrated as follows. First of all, the wireless signal receiver 340 is supported on the carrier 320. Then, the carrier 320 is pushed forwardly in the horizontal direction indicated by the arrow. The carrier 320 is moved with respect to the receiving portion 310 until the confining plate 324 of the carrier 320 is sustained against the right-side border of the confining aperture 312 of the receiving portion 310. Afterwards, the carrier door 330 is rotated and closed, as can be seen in FIG. 5B.

From the above description, the storing structure of the wireless mouse according to the present invention may facilitate a user to insert/withdraw the wireless signal receiver into/from the receiving portion without impairing the outward appearance of the wireless mouse. Since the carrier is movable with respect to the receiving portion, the carrier may be pulled out from or pushed in the cover member of the wireless mouse in order to store or remove the wireless mouse as required.

In the above embodiments, the carrier is pulled out from the rear side of the wireless mouse, as is shown in FIG. 5B. It is noted that, however, those skilled in the art will readily observe that numerous modifications and alterations may be made while retaining the teachings of the invention. For example, the carrier may be pulled out from a lateral side of the wireless mouse as long as enough space is sufficient for accommodating related components therein.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A storing structure of a wireless mouse for storing a wireless signal receiver therein, said storing structure comprising:
a cover member including a receiving portion therein;
a carrier disposed in said receiving portion and movable to be protruded from said cover member; and
a carrier door pivotally coupled to said carrier.

2. The storing structure according to claim 1 wherein said carrier door further includes a hooking element engageable with said cover member.

3. The storing structure according to claim 1 wherein said carrier includes a pivotal hole to be coupled with said carrier door.

4. The storing structure according to claim 3 wherein said carrier door includes a rotating shaft corresponding to said pivotal hole such that said carrier door is pivotal about said rotating shaft.

5. The storing structure according to claim 1 wherein said receiving portion includes a confining aperture for confining the movable range of said carrier.

6. The storing structure according to claim 5 wherein said carrier includes a confining plate penetrating through said confining aperture such that the movable range of said carrier is determined by the length of said confining aperture.
